(19) United States
(12) Patent Application Publication
(10) Pub. No.: US 2007/0169303 A1
(43) Pub. Date: Jul. 26, 2007

(54) PAINT TRAY ATTACHMENT FOR ROLLER BRUSH

(76) Inventor: Gregory R. Hart, Puyallup, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/626,805

(22) Filed: Jan. 24, 2007

Related U.S. Application Data
(60) Provisional application No. 60/762,003, filed on Jan. 24, 2006.

(51) Int. Cl. B05C 21/00

(52) U.S. Cl. 15/257.06

(57) ABSTRACT

A paint tray attachment having vertical extensions configured to engage a roller to supply a sufficient amount of torque such that the roller rotates to distribute paint therearound. The paint tray attachment has a base portion which adheres or is otherwise operatively attached to a paint tray, and the plurality of extensions to engage a paint roller.

### RELATED APPLICATIONS

This application claims priority of U.S. Ser. No. 60/762,003, filed Jan. 24, 2006.

### BACKGROUND OF THE INVENTION

In general, paint trays have been utilized for providing a paint supply for rollers. Paint trays generally have a lower sump area where paint is supplied in an upper angled surface that provides a surface area for the painter to place the flexible porous roller surface of the roller with paint thereon and more evenly distribute paint about the roller.

It has been found that paints, whether they are oil-based or water-based, have a sufficiently high viscosity and overall thickness in composition such that it can sometimes be difficult and time-consuming to spread the paint around the flexible porous surface of the roller. Present analysis indicates that there is an insufficient amount of torque that can be applied to the paint roller to properly induce rotation about the upper incline surface of a paint tray. Further, because paint is distributed about the roller, and because wet paint by nature is fairly adhesive to anything it comes in contact with, it is difficult to induce a torque upon the roller by any exterior object without spreading the paint in undesirable locations. Further, it is challenging to properly distribute the paint about the outer surface of a roller evenly without having indentations thereon which will manifest themselves into an improper application of paint on a wall. For example, if the outer flexible porous roller surface is excessively indented in portions, there will be less paint on these portions and less paint will be applied to that respective area on the wall that the roller is in engagement with. Therefore, provided herein is a convenient method for aiding in distributing paint about a roller in the upper surface of the paint tray or similar type of structure.

### BRIEF DESCRIPTION OF THE DRAWINGS

FIG. 1 shows an isometric view of a paint assembly;

FIG. 2 shows an isometric view of a paint tray with a paint attachment affixed to the upper angled surface of the paint tray;

FIG. 3 shows a side view of a painter attachment;

FIG. 4 shows a partial sectional view of any paint tray assembly where the paint roller is in the lower portion of the paint tray amongst a paint sump;

FIG. 5 shows a side view of the paint tray attachment.

### SUMMARY OF THE INVENTION

Disclosed herein is one form of a paint tray attachment adapted to attach to the upper angled surface of a paint tray having a paint sump. The upper angled surface of the tray has first and second lateral portions and a lateral central portion and the upper angled surface further has a longitudinal axis extending from a lower portion to an upper portion. The tray is adapted to hold paint therein and be used in combination with a paint roller having a flexible porous roller surface.

The paint tray attachment comprises a roller engagement surface having a plurality of vertically extending members. The vertically extending members are adapted to engage the flexible porous roller surface of the paint roller and provide a torque thereon as the roller moves with respect to the vertically extending members.

The paint tray attachment further comprises an attachment region operatively configured to attach to the upper angled surface of the paint tray between the first and second lateral portions and align substantially in the longitudinal direction from the lower region to the upper region of the upper angled surface to be adapted to engage the flexible porous roller surface of the roller as it travels in the longitudinally forward direction from the paint sump to provide a torque thereon to rotate the paint roller and distribute paint properly about the flexible porous roller surface.

In one form of the paint tray attachment, the attachment region comprises a foam layer with an adhesive portion thereunder where prior to attaching the paint tray attachment to the upper angled surface, and a removable protective strip is placed thereon. In another form, the paint tray attachment is configured to be retrofitted to the upper angle surface of the paint tray, and in another embodiment the flexible porous roller surface engages the plurality of vertically extending members after paint is coated on a portion thereof in the paint sump, and the plurality of vertically extended members do not sufficiently indent the flexible porous roller surface of the paint roller to unevenly apply the paint thereafter upon a surface to be painted. Additionally, in another form, extending members are at least twice as high from an attachment region upper surface near the attachment region to a tip portion of the plurality of vertically extending members. Finally, the plurality of vertically extending members may have a longitudinal width of at least 1 millimeter.

The disclosure also includes a method of distributing paint about a flexible porous roller surface of a paint roller. This method comprises positioning a paint tray attachment substantially along a longitudinal axis of a paint tray from the lower portion to the upper portion of the upper angled surface. It further comprises providing a plurality of vertical extensions on the paint tray attachment extending from a base surface, and placing paint in a paint sump of a paint tray and positioning the flexible porous roller surface of a paint roller therein to distribute paint on a portion of the flexible porous roller surface. Finally, the method comprises repositioning the paint roller of the upper angle surface of the paint tray in a longitudinally forward direction where the vertical extension members engage the flexible porous roller surface of the paint roller and apply a torque thereon to rotate the roller member of the paint roller where the upper angled surface distributes paint around the flexible porous roller surface. The longitudinal thickness of the vertical extending members is sufficiently small that the flexible porous roller surface does not have significant indentations thereon to affect the distribution of paint around the flexible porous roller surface.

In another form of the above method, the area of the flexible porous roller surface that engages the paint tray attachment is the affected area and the amount of paint distribution therearound is substantially similar to the adjacent areas of the roller member in the lateral direction. In yet another form, vertically extending members have a longitudinal thickness no greater than 2 mm, or they may be spaced apart at intervals greater than 1 cm. In a different embodiment, the longitudinal thickness of the vertically extending members is at least less than one third of the height of the vertically extending members.

The attachment can also comprise a plurality of vertically extending members extending from the base surface of the attachment region and the plurality of vertically extending members extending from the base surface to a height at least twice the mean width of the vertically extending members.

In various other forms, the plurality of vertically extending members are spaced apart from one-another at least 0.5 centimeters; no more than 1.5 centimeters; and no more than 2.5 centimeters.

In a different embodiment, the mean width of the vertically extending members is at least 0.5 millimeters. Finally, the tip portion of the plurality of vertically extending members is configured to engage a flexible porous roller surface of a paint roller with paint encoded thereon, so the engagement of the tip portions indent within the flexible porous roller surface but do not have a sufficient indentation width so the surface tension of the paint is broken to create air gaps at the point of contact with the tip portions of the vertically extending members.

### DETAILED DESCRIPTION OF THE PREFERRED EMBODIMENTS

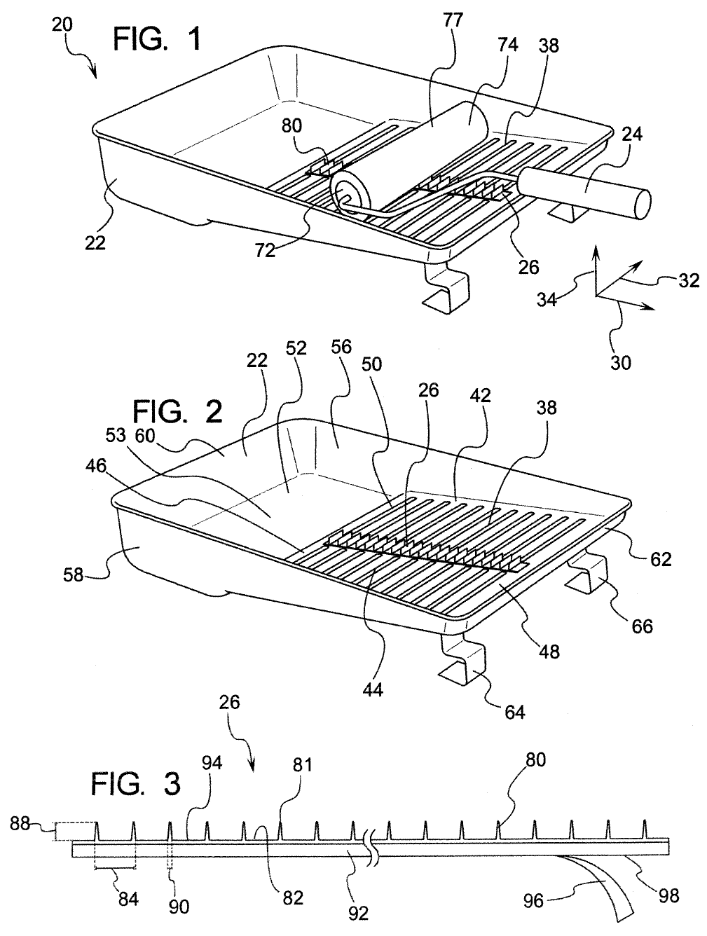

As shown in FIG. 1, there is a paint assembly 20 comprising a paint tray 22, a roller 24 and a paint tray attachment 26. To aid in the description of the paint assembly and, more particularly, the paint tray attachment 26, an axis system is defined where as shown in FIG. 1, the axis indicated at 30 defines a longitudinal axis pointing in the longitudinal forward direction. The axis indicated at 32 generally defines a lateral direction, and the axis indicated at 34 defines a vertical direction. Of course the axes system is set forth for general reference purposes and is not intend to limit the invention to these specific orthogonal relationships, but is only outlined to indicate a general direction for describing various elements of the disclosure.

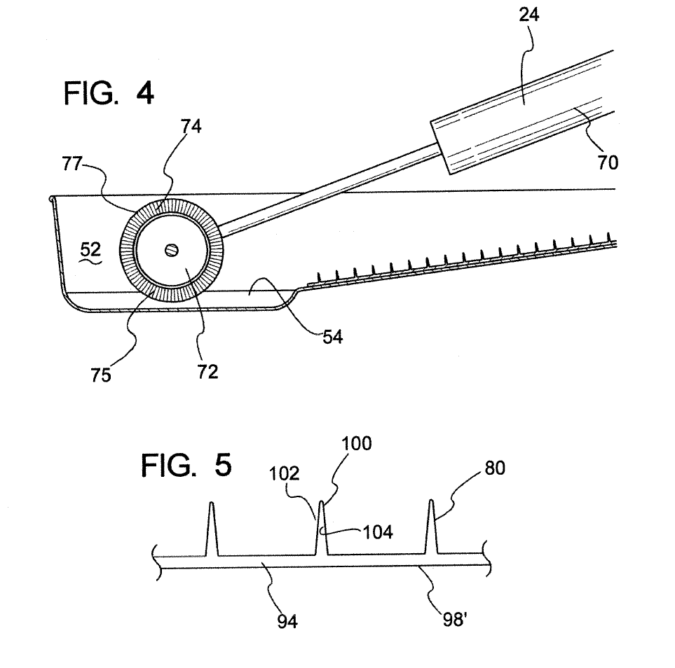

Now referring to FIG. 2, the paint tray 22 generally comprises an upper angled surface 38. The upper angled surface comprises a first lateral region 40 and a second lateral region 42. Further, in between the first and second lateral regions is a lateral central portion 44, and the upper angled surface 38 comprises a lower longitudinal region 46 and an upper longitudinal region 48. In one form, the upper angled surface has a plurality of bumps (otherwise referred to as upward extensions) 50 that extend generally substantially in the lateral direction but on occasion have a slant inward or outward in the longitudinal direction to aid in the paint flow draining back to the sump region. The sump region indicated at 52 is, as best shown in FIG. 4, adapted to hold paint 54 therein. The paint tray further comprises lateral walls 56 and 58 at the first and second lateral regions as well as longitudinal walls 60 and 62 at the longitudinal rearward and forward portions respectively. Normally, some sort of legs in the longitudinally forward portion indicated at 64 and 66 are provided to maintain the orientation of the upper angled surface at a slight angle draining back to the sump 52.

With the foregoing description of the tray in mind, there will be a description of the roller indicated at 24 with reference to FIGS. 1 and 4. In general, the roller comprises a handle 70 and a roller member 72. The roller is of a conventional design where normally a flexible porous roller surface 74 comprises the outer surface portion of the roller member 72. The flexible porous roller surface 74 can be in a variety of forms, but generally has a certain amount of volume capacitance to hold paint therearound, and it essentially has an interior cavity sponge structure to store paint therein for even distribution on a surface that is desired to be painted. Of course the aforementioned portions are well-known in the prior art and have been utilized by painters for many decades for distributing paint. Further, a variety of forms of rollers and trays can be utilized where an accessory to the roller 24 and the tray 22 aids in the distribution of paint about the flexible porous roller surface 74. Referring now to FIG. 2, there is shown the paint tray attachment 26 that is attached to the upper angled surface 38 of the paint tray 22.

As shown in FIG. 3, there is shown one form of the paint tray attachment 26 where a plurality of vertically extending members 80 extend from a base surface 82. In one form, the distance between the members is between 0.5 cm-2.5 as indicated in the left-hand portion of FIG. 3 at dimension 84. Further, the height of the vertically extending members as indicated by the dimension indicated at 86 is generally between 0.1 and 1.5 cm. Finally, in one form, the longitudinal width of each member is approximately 0.5-3 millimeters, as indicated by dimension 90 in FIG. 3. Of course, these dimensions can fluctuate such that in one form, the ranges can have intermedial values therein. The plurality of vertically extending members can be various sizes, and the definition thereof can be any two of the members attached to the attachment region and a portion of the roller engagement surface. In one form, as shown in FIG. 3, the tip portion 81 to the attachment region upper surface (the base surface) 82 is at least twice the width as indicated at 90 (for example). The mean width of the vertically extending members is the average width from the lower portion where they engage the base surface to the tip portion 81.

In one form, a foam portion 92 is positioned adjacent to a rubberlike member 94 that uses the flexible member 94 which comprises the base surface 82 and the plurality of vertically extending members 80. In this form, the foam portion 92 has a removable protective strip 96 that protects an attachment region 98. The attachment region in one form is an adhesive portion that has a sufficient level of adhesiveness to stick to the upper angled surface 38 as shown in FIG. 2. Referring to FIG. 5, there is shown a variation where the foam portion is not utilized and the flexible member 94 has the adhesive region 98′ directly positioned thereunder. As shown in FIG. 5, it can be appreciated that the vertically extending members 80 have forward and rearward surfaces 100 and 112 that in one form are angled with respect to one another, indicated at 104 at an angle of 15° in one form. Of course this can fluctuate in the range of plus or minus 10°, but it has been found that such an angle is desirable to minimally indent the flexible porous roller surface 74 of the roller so as to not hamper the distribution of paint therearound.

In one form the plurality of vertically extending members are comprised of a somewhat flexible-like compound, such as a rubber-based or polyurethane type material. It should be noted that although referred to as “vertically extending,” the members 80 are substantially vertically extending when placed on the angled surface of the paint tray.

Therefore, in one method of utilizing the paint assembly 20, the paint tray attachment has the movable protective strip 96 removed from the attachment region 98 which in one form is that an adhesive portion either to the foam portion 92 or directly under the surface indicated at 98′ as shown in FIG. 5. In one form, the strip can extend into the sump in the area 53. Of course a variety of attachment systems can be utilized, but a proper adhesive is one preferred form. As shown in FIG. 2, the adhesive strip is attached somewhere in the central region of the upper angled surface 38 so the plurality of vertically extending members 80 as shown in FIG. 3 are adapted to engage the flexible porous roller surface 74 of the roller member 72. Basically, as shown in FIG. 4, the flexible porous roller surface 74 engages the paint sump region indicated at 54 and a portion of the paint is applied to the exterior portion of the flexible porous roller surface 74. Of course, a variety of other rollers 72 can be provided, but most commonly, there is some form of paint retention value of the roller surface so as to minimize the amount of returning to the paint tray 22 during the painting process. For example, the flexible porous roller surface could be of a particular design that intentionally does not provide a uniform coating. However, as noted above, the plurality of vertically extending members 80 are constructed in such a manner so as to minimize the indentation and hence introducing the retention of paint within the flexible porous roller surface 74. Therefore, when the user wishes to distribute the paint from the lower region indicated at 75 to the entire circumferential region 77 of the roller 72, the painter simply draws the paint roller 24 as shown in FIG. 1 up the upper angled surface 38 where the painter tray attachment 26 provides a torque about the roller member 72, and paint is hence distributed about the entire circumferential region 77. In general, the surface tension of the paint is sufficient around the roller where the tip portion of the vertically extending members is not sufficient break the surface tension in a tangential width direction, so as to not have indentations which are noticeable when the roller is applying paint to a surface to be painted, such as a wall or ceiling. In other words, an excessive indentation will create holes or swatches and can create portions where the paint is not substantially evenly distributed around the roller, thereby not allowing a proper distribution when applied to a surface to be painted. Of course, the attachment 26 can be fastened to the upper angled surface 38 by way of a plurality of locations such as near the first or second lateral locations 38 and 40, or essentially anywhere along the upper surface to provide a torque for rotation of the roller member 72.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicant's general concept.

I therefore claim:

1. A paint tray attachment adapted to attach to the upper angled surface of a paint tray having a paint sump, the upper angled surface having first and second lateral portions and a lateral central portion, the upper angled surface further having a longitudinal axis extending from a lower portion to an upper portion, the tray adapted to hold paint therein and be used in combination with a paint roller having a flexible porous roller surface, the paint tray attachment comprising:
a. a roller engagement surface having a plurality of vertically extending members, the vertically extending members adapted to engage the flexible porous roller surface of the paint roller and provide a torque thereon as the roller moves with respect to the vertically extending members
b. an attachment region operatively configured to attach to the upper angled surface of the paint tray between the first and second lateral portions and align substantially in the longitudinal direction from the lower region to the upper region of the upper angled surface to be adapted to engage the flexible porous roller surface of the roller as it travels in the longitudinally forward direction from the paint sump to provide a torque thereon to rotate the paint roller and distribute paint properly about the flexible porous roller surface.

2. The paint tray attachment as recited in claim 1 where the attachment region comprises a foam layer with an adhesive portion thereunder where prior to attaching the paint tray attachment to the upper angled surface, a removable protective strip is placed thereon.

3. The paint tray attachment as recited in claim 1 where the paint tray attachment is configured to be retrofitted to the upper angle surface of the paint tray.

4. The paint tray attachment as recited in claim 1 where the flexible porous roller surface engages the plurality of vertically extending members after paint is coated on a portion thereof in the paint sump, and the plurality of vertically extended members do not sufficiently indent the flexible porous roller surface of the paint roller to unevenly apply the paint thereafter upon a surface to be painted.

5. The paint tray attachment as recited in claim 1 where the plurality of vertically extending members are at least twice as high from an attachment region upper surface at the attachment region to a tip portion of the plurality of vertically extending members.

6. The paint tray attachment as recited in claim 5 where the plurality of vertically extending members have a longitudinal width of at least 1 millimeter.

7. A method of distributing paint about a flexible porous roller surface of a paint roller, the method comprising:
a. positioning a paint tray attachment substantially along a longitudinal axis of a paint tray from the lower portion to the upper portion of the upper angled surface,
b. providing a plurality of vertical extensions on the paint tray attachment extending from a base surface,
c. placing paint in a paint sump of a paint tray and positioning the flexible porous roller surface of a paint roller therein to distribute paint on a portion of the flexible porous roller surface,
d. repositioning the paint roller of the upper angle surface of the paint tray in a longitudinally forward direction where the vertical extension members engage the flexible porous roller surface of the paint roller and apply a torque thereon to rotate the roller member of the paint roller where the upper angled surface distributes paint around the flexible porous roller surface,
e. whereas the longitudinal thickness of the vertical extending members is sufficiently small that the flexible porous roller surface does not have significant indentations thereon to affect the distribution of paint around the flexible porous roller surface.

8. The method as recited in claim 7 where the area of the flexible porous roller surface that engages the paint tray attachment is the affected area and the amount of paint distribution therearound is substantially similar to the adjacent areas of the roller member in the lateral direction.

9. The method as recited in claim 7 where the vertically extending members have a longitudinal thickness no greater than 2 mm.

10. The method as recited in claim 9 where the vertically extending members are spaced apart at intervals greater than 1 cm.

11. The method as recited in claim 7 where the paint tray attachment is adhesively attached to an upper surface of the paint tray.

12. The method as recited in claim 11 where the longitudinal thickness of the vertically extending members is at least less than one third of the height of the vertically extending members.

13. A paint tray attachment for an upper surface of a paint tray, the paint tray attachment comprising:
a. an attachment region having an adhesive portion operatively configured to adhere to the upper surface of the paint tray, the attachment region having a base surface,
b. a plurality of vertically extending members extending from the base surface of the attachment region, the plurality of vertically extending members extending from the base surface to a height at least twice the mean width of the vertically extending members.

14. The paint tray attachment as recited in claim 13 where the plurality of vertically extending members are spaced apart from one-another at least 0.5 centimeters.

15. The paint tray attachment as recited in claim 13 where the plurality of vertically extending members are spaced apart from one-another no more than 1.5 centimeters.

16. The paint tray attachment as recited in claim 13 where the plurality of vertically extending members are spaced apart from one another not more than 2.5 centimeters.

17. The paint tray attachment as recited in claim 13 where the mean width of the vertically extending members is at least 0.5 millimeters.

18. The paint tray attachment as recited in claim 13 where the tip portion of the plurality of vertically extending members is configured to engage a flexible porous roller surface of a paint roller with paint encoded thereon, so the engagement of the tip portions indent within the flexible porous roller surface but do not have a sufficient indentation width so the surface tension of the paint is broken to create air gaps at the point of contact with the tip portions of the vertically extending members.

19. The paint tray attachment as recited in claim 18 where the plurality of vertically extending members are spaced apart from one another not more than 2.5 centimeters.

20. The paint tray attachment as recited in claim 18 where the mean width of the vertically extending members is at least 0.5 millimeters.
